(19) United States
(12) Patent Application Publication
(10) Pub. No.: US 2026/0154299 A1
(43) Pub. Date: Jun. 4, 2026

(54) CENTRALIZED ANALYTICS SUPPORT AND ENABLEMENT

(71) Applicant: Wells Fargo Bank, N.A., San Francisco, CA (US)

(72) Inventors: Ramin Mobasseri, San Ramon, CA (US); Duncan Samuel Calvert, Chicago, IL (US); Megan Ellyn Pratt, Oakland, CA (US); Tiffany Zhang, San Francisco, CA (US)

(21) Appl. No.: 18/967,415

(22) Filed: Dec. 3, 2024

(51) Int. Cl. G06F 16/3329; G06F 16/334; G06F 16/951

(52) U.S. Cl. CPC G06F 16/33295; G06F 16/3347; G06F 16/951

(57) ABSTRACT

Techniques are described that provide self-service functionality for data analytics with built-in support guidance. The techniques include a collective intelligence system coupled with a centralized analytics support and enablement (CASE) system. The collective intelligence system is configured to build an indexed database based on documentation from disparate internal and external data sources. The CASE system provides a self-service function that includes a user interface as a search function and a chatbot, each configured to receive user queries regarding at least one of data or data analytics and return answers or results in response to the user queries based on the indexed database. Based on an inability of the chatbot and/or the search function to return an answer or result in response to a user query, the CASE system is configured to route the user query to a selected agent for either asynchronous or synchronous support for the user query.

### TECHNICAL FIELD

This disclosure relates to computer-based systems for managing data, and more specifically, to managing requests for data analytics.

### BACKGROUND

A number of technology platforms exist that provide users or businesses the ability to collect and store large amounts of data. Such a platform may exist to provide users or businesses the ability to gain business insights on data. However, for many businesses, such as banks, operational risks and security threats that can arise with data mismanagement must be minimized to maintain good industry standards and regulations that pertain to data collection and use. To avoid financial crises and promote the stability of the financial system, banks may be subject to strict data regulation requirements. These regulations mandate that banks report, monitor, and analyze vast amounts of data relating to their risk exposures, capital adequacy, liquidity, and systemic importance.

Data analysis products enable businesses or enterprises to collect, store, clean, and analyze large amounts of data. Such products may provide analysts the ability to create a dataset and develop predictive models, e.g., using machine learning algorithms, or otherwise analyze the dataset to gain business insights and comply with the relevant regulations.

### SUMMARY

In general, this disclosure describes techniques to provide self-service functionality for data analytics with built-in support guidance. More specifically, the techniques include a collective intelligence system coupled with a centralized analytics support and enablement (CASE) system. The collective intelligence system is configured to build a centralized, indexed database from disparate internal and external data sources. The CASE system includes a front-end user interface as both a traditional search function and a chatbot, each configured to return answers or results in response to data analytics user queries based on the indexed database. In situations where the chatbot and/or the search function are unable to return an answer or result of sufficient quality in response to a user query, the CASE system is further configured to facilitate either asynchronous or synchronous support for the user query. For example, the CASE system may include one or more routing systems to redirect the user query to an appropriate human agent or data scientist via an asynchronous ticketing system or a synchronous live agent session across all data analysis products.

Conventional processes for accessing data and data analytics require a human requestor to submit a support ticket via a product-specific ticketing system to a human agent or data scientist for manual provisioning of the requested data and/or data analytics. The conventional processes require domain expertise, are error prone, and are inefficient (e.g., may result in duplicated efforts). The techniques of this disclosure may provide one or more advantages and practical applications. For example, the indexed database built by the collective intelligence system enables automated search and retrieval of requested data and/or data analytics without requiring domain expertise to identify one or more data sources from which to manually provision the data and/or analytics. As another example, the CASE system facilitates the self-service functionality for data analytics by providing both the traditional search function and the chatbot to receive user queries and display the results. Moreover, both the collective intelligence system and the chatbot of the CASE system may be implemented as microservices that can be deployed across various environments and exposed using application programming interfaces (APIs). The resulting centralization and automation of data search and retrieval processes may reduce or avoid the errors and inefficiencies inherent in the conventional, manual processes.

As a further example of the advantages and practical applications of the disclosed techniques, the CASE system may provide the self-service functionality in a hierarchical manner such that a user query unable to be answered via the chatbot will be attempted via the search function. If the user query cannot be answered via either the chatbot or the search function, the CASE system may route the user query to an appropriate agent via a product-agnostic routing and/or ticketing system. In one example, if the chatbot is unable to answer the user query and/or the user query indicates a request to speak to a live agent, the chatbot may route the user query to a live agent session based on an appropriate agent being currently available and, if an appropriate agent is not currently active, automatically generate a support ticket for the user query and route the support ticket to the appropriate agent for asynchronous assistance. In this way, the CASE system provides an end-to-end workflow that seamlessly interconnects the front-end user interface for self-service data and/or analytics access with synchronous and asynchronous human agent support systems. Furthermore, in some scenarios, the user query and/or a support ticket generated based on the user query may be converted into a product enhancement ticket to modify at least a portion of the data product based on the user query.

In one example, this disclosure is directed to a computing system comprising memory and processing circuitry in communication with the memory. The processing circuitry is configured to generate an indexed database based on a plurality of documentation from disparate data sources; provide a self-service function that includes a user interface as a search function and a chatbot, each configured to receive user queries regarding at least one of data or data analytics and return answers or results in response to the user queries based on the indexed database; and based on an inability to return an answer or result in response to a user query, route the user query to an agent selected from a plurality of agents for one of asynchronous or synchronous support for the user query.

In another example, this disclosure is directed to a method comprising generating, by a computing system, an indexed database based on a plurality of documentation from disparate data sources; providing, by the computing system, a self-service function that includes a user interface as a search function and a chatbot, each configured to receive user queries regarding at least one of data or data analytics and return answers or results in response to the user queries based on the indexed database; and based on an inability to return an answer or result in response to a user query, routing, by the computing system, the user query to an agent selected from a plurality of agents for one of asynchronous or synchronous support for the user query.

In a further example, this disclosure is directed to non-transitory computer readable media comprising instructions that, when executed, cause one or more programmable processors to generate an indexed database based on a plurality of documentation from disparate data sources; provide a self-service function that includes a user interface as a search function and a chatbot, each configured to receive user queries regarding at least one of data or data analytics and return answers or results in response to the user queries based on the indexed database; and based on an inability to return an answer or result in response to a user query, route the user query to an agent selected from a plurality of agents for one of asynchronous or synchronous support for the user query.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram illustrating an example network system including a collective intelligence system and a centralized analytics support and enablement (CASE) system, in accordance with one or more aspects of the present disclosure.

FIG. 2A is a conceptual diagram illustrating example operations of a collective intelligence system and a CASE system, in accordance with one or more aspects of the present disclosure.

FIG. 2B is a conceptual diagram illustrating example data processing operations performed by the collective intelligence system of FIG. 2A in greater detail.

FIG. 2C is a conceptual diagram illustrating an example routing flow for support forms by the CASE system of FIG. 2A.

FIG. 2D is a conceptual diagram illustrating an example routing flow for live agent support by the CASE system of FIG. 2A.

FIG. 3 is a block diagram illustrating an example computing system including a CASE unit and a collective intelligence unit, in accordance with one or more aspects of the present disclosure.

FIG. 4 illustrates an example user interface of a CASE system, in accordance with one or more aspects of the present disclosure.

FIG. 5 is a flowchart illustrating example operations to provide self-service functionality for data analytics with built-in support guidance, in accordance with one or more aspects of the present disclosure.

### DETAILED DESCRIPTION

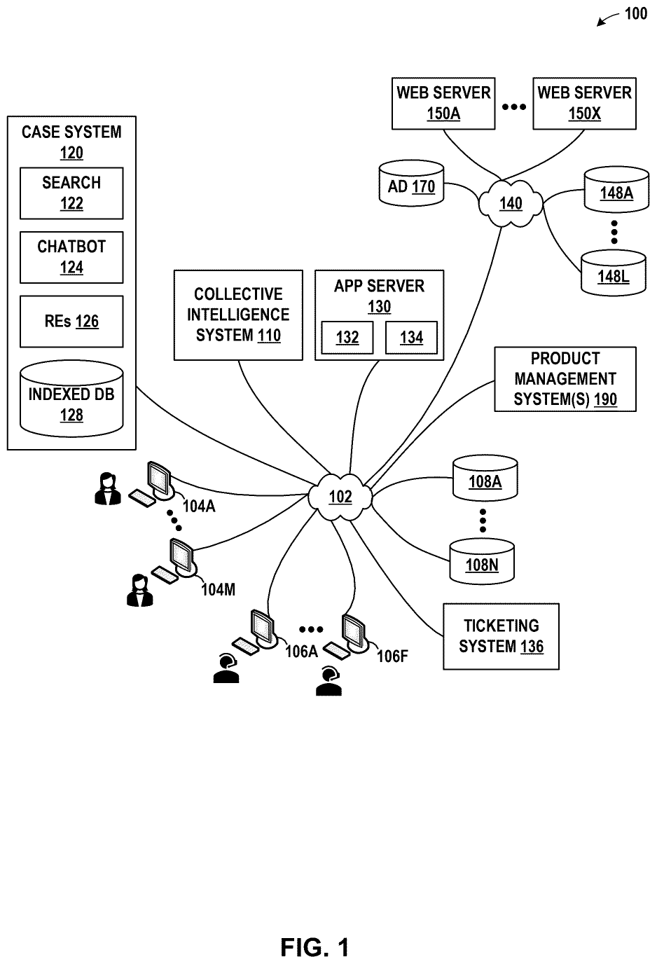

FIG. 1 is a block diagram illustrating an example network system 100 including a collective intelligence system 110 and a centralized analytics support and enablement (CASE) system 120, in accordance with one or more aspects of the present disclosure.

Network system 100 includes a private network 102 and a public network 140. Devices connected to private network 102 may be part of a secure network not normally accessible to the public, such as an enterprise network, organizational network, or local area network. In some examples, devices and/or computing systems on private network 102 may be considered to be on an enterprise network, which may be controlled and/or operated by a business enterprise or other organization. Although private network 102 is illustrated as a single network and may be principally located within one location, private network 102 may also comprise multiple networks and be geographically distributed across multiple locations.

A number of devices and/or systems are shown connected to private network 102 in FIG. 1. Such devices and systems include user or requester devices 104A-104M (collectively, “requester devices 104”), data scientist or agent devices 106A-106F (collectively, “agent devices 106”), internal data sources 108A-108N (collectively, “internal data sources 108”), collective intelligence (CI) system 110, CASE system 120, at least one application server 130, a ticketing system 136, and one or more product management systems 190.

Public network 140 may be primarily described as a public network, such as the internet. However, techniques in accordance with one or more aspects of the present disclosure may apply to similar systems in which network 140 is implemented as a private network. Public network 140 may be used by requester devices 104, agent devices 106, CASE system 120 and/or CI system 110 within private network 102 to access external data sources 148A-148L (collectively, “external data sources 148”), web sites hosted by web servers 150A-150X (collectively, “web servers 150”), and/or active directory (AD) 170 for the business enterprise or other organization associated with private network 102. In some examples, one or more application servers, including application server 130, may be accessible via public network 140 instead of private network 102. In further examples, one or more applications or computing systems operated by various cloud-based service providers may also be accessible by the devices and/or systems connected to private network 102 via public network 140.

Private network 102 may include various other network devices, as is typical of a network. Although not shown, such devices may include one or more network hubs, network switches, network routers, satellite dishes, or any other network equipment. Such devices or components may be operatively inter-coupled, thereby providing for the exchange of information between computers, devices, or other components (e.g., between one or more client devices or systems and one or more server devices or systems). As with private network 102, public network 140 may include other network devices not specifically illustrated in FIG. 1, such as one or more network hubs, network switches, network routers, satellite dishes, or any other network equipment.

Each of requester devices 104 may be any suitable computing device capable of being operated by a user or requester (not shown). Similarly, each of agent devices 106 may be any suitable computing device capable of being operated by a data scientist or agent (not shown). Such requester devices 104 and agent devices 106 may include mobile devices, tablets, laptop computers, desktop computers, workstations, or any other suitable computing device. Typically, each of requester devices 104 and agent devices 106 is capable of accessing other computing systems within private network 102 and outside of private network 102 (e.g., through public network 140). For instance, one or more of requester devices 104 and/or one or more of agent devices 106 may interact with, over public network 140, external data sources 148 and/or one or more web sites hosted by web servers 150.

One or more applications may be hosted by application server 130 for access and use by requester devices 104 and/or agent devices 106. The hosted applications may further include one or more data science and analytics (“data”) products 132 used by data scientists or agents of agent devices 106 to analyze data and to present insights of their analysis. Data products 132 may include internal enterprise tools or applications along with commercial tools or applications, such as Alteryx, Tableau, Apache Spark, TensorFlow, Microsoft Power BI, or the like. The hosted applications may also include a chat application 134, such as Microsoft Teams, Slack, Zoom, or the like, through which one or more of the requesters of requester devices 104 and/or one or more of the agents of agent devices 106 may communicate. Although illustrated in FIG. 1 as being included in private network 102, i.e., on-premises, in other examples one or more of applications 132, 134 may be cloud-based applications stored in one or more data centers or other storage means accessible via public network 140 and operated by various cloud-based service providers.

The users or requesters using requester devices 104 may be employees of the business enterprise or other organization associated with private network 102. The requesters of requester devices 104 may be tasked with accessing and reporting data and/or data analytics with respect to certain initiatives, business units, or divisions of the business enterprise. The data scientist or agents using agent devices 106 may also be employees of the business enterprise or other organization associated with private network 102. The agents of agent devices 106 may be tasked with performing the data analysis on behalf of the requesters of requester devices 104 and/or resolving issues associated with the requested data and/or data analytics or with data products 132. In some examples, one or more agents of agent devices 106 may be “product owners” or “product engineers” responsible for the maintenance and operation of respective data products 132. In these examples, the one or more agents of agent devices 106 may use one or more product management systems 190 to manage their respective data products 132, including maintaining a queue of issues and feature enhancements.

Conventional processes for accessing data and data analytics require a requestor of requester devices 104 to submit a support ticket, e.g., via ticketing system 136, requesting the data and/or data analytics. A data scientist or agent of agent devices 106 may be assigned, or otherwise retrieve, the support ticket via ticketing system 136 and manual provision the requested data and/or data analytics. The conventional processes require domain expertise, are error prone, and are inefficient (e.g., may result in duplicated efforts). For example, a user or requester may need to know how to find web customer data for the business enterprise. In the convention processes, the requester would manually submit a support ticket requesting the location of web customer data. An agent may process the support ticket within a few days, e.g., 1-3 days, and, to answer the question, may need to manually identify a subject matter expert in the web customer data for the business enterprise to determine which data products or systems hold at least a portion of the requested data. Based on the answers provided by the agent, the requester may then need to submit multiple support tickets for each data product or system in which a portion of the web customer data is held to request access to the requested data or analytics of the requested data. This process may take several weeks to complete.

This disclosure describes techniques to provide self-service functionality for data analytics with built-in support guidance. More specifically, the techniques include CI system 110 coupled with CASE system 120. CI system 110 is configured to build a centralized, indexed database 128 from disparate internal data sources 180 and external data sources 148. For example, CI system 110 periodically batch loads documentation from both internal data sources 108 and external data sources 148 via application programming interface (API) calls, and performs pre-processing, including format normalization, de-duplication, and aggregation of content of the documentation. CI system 110 then vectorizes and indexes the content of the documentation into indexed database 128.

CASE system 120 includes a front-end user interface as both a traditional search function 122 and a chatbot 124. Each of search function 122 and chatbot 124 are configured to receive user queries from requesters of requester devices 104 regarding at least one of data or data analytics and return answers or results in response to the user queries based on indexed database 128. In situations where search function 122 and/or chatbot 124 are unable to return an answer or result of sufficient quality in response to a user query, CASE system 120 is further configured to facilitate either asynchronous or synchronous support for the user query. For example, CASE system 120 includes one or more routing systems (“REs”) 126 configured to redirect the user query to an appropriate data scientist or agent of agent devices 106 via an asynchronous ticketing system, e.g., ticketing system 136, or a synchronous live agent session, e.g., via chat application 134.

Routing engines 126 may select the appropriate data scientist or agent of agent devices 106 based on a data product or other context identified in the user query, expertise or knowledge level of the agents associated with the identified data product or other context, and/or availability of the agents based on data retrieved from active directory 170. In some cases, during asynchronous or synchronous support for the user query by the selected agent, the selected agent may determine a need for a new feature and/or correction of an issue for the data product identified in the user query. Based on an indication from the selected agent, CASE system 120 may generate a product enhancement ticket to modify at least a portion of the data product based on the user query, and send control signals to one or more computing devices operating as product management systems 190 instructing the one of product management system 190 associated with the data product to include the product enhancement ticket in a queue of issues and feature enhancements for the data product.

The techniques of this disclosure may provide one or more advantages and practical applications. For example, CASE system 120 and indexed database 128 built by CI system 110 enable automated search and retrieval of data and/or data analytics for requesters of requester devices 104 without requiring domain expertise of data scientists or agents of agent devices 106 to identify one or more data sources from which to manually provision the data and/or data analytics. As another example, CASE system 120 facilitates the self-service functionality for data analytics by providing both the traditional search function 122 and chatbot 124 to receive user queries and display the results. Moreover, both CI system 110 and chatbot 124 of CASE system 120 may be implemented as microservices that can be deployed across various environments and exposed using APIs. The resulting centralization and automation of data search and retrieval processes may reduce or avoid the errors and inefficiencies inherent in the conventional, manual processes.

As a further example of the advantages and practical applications of the disclosed techniques, CASE system 120 may provide the self-service functionality in a hierarchical manner such that a user query unable to be answered via chatbot 124 will be attempted via search function 122. If the user query cannot be answered via either chatbot 124 or search function 122, CASE system 120 may route the user query to an appropriate data scientist or agent of agent devices 106. In one example, if chatbot 124 is unable to answer the user query and/or the user query indicates a request to speak to a live agent, CASE system 120 may use routing engines 126 to select the appropriate agent based on a data product and/or other context identified in the user query and based on which agents of agent devices 106 are currently available. CASE system 120 may then establish a live agent session via chat application 134 between the requester of requester devices 104 from which the user query was received and the selected agent of agent devices 106. If an appropriate agent is not currently active, chatbot 124 may automatically generate a support ticket for the user query and route the support ticket to the appropriate agent for asynchronous assistance via ticketing system 136. In this way, CASE system 120 provides an end-to-end workflow that seamlessly interconnects the front-end user interface for self-service data and/or analytics access with synchronous and asynchronous human agent support systems.

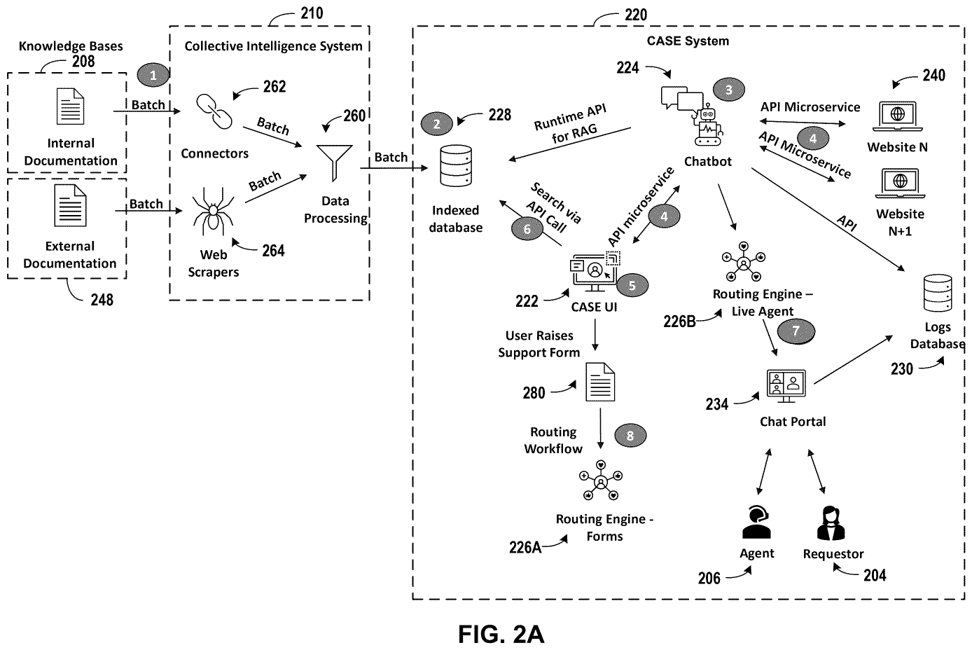

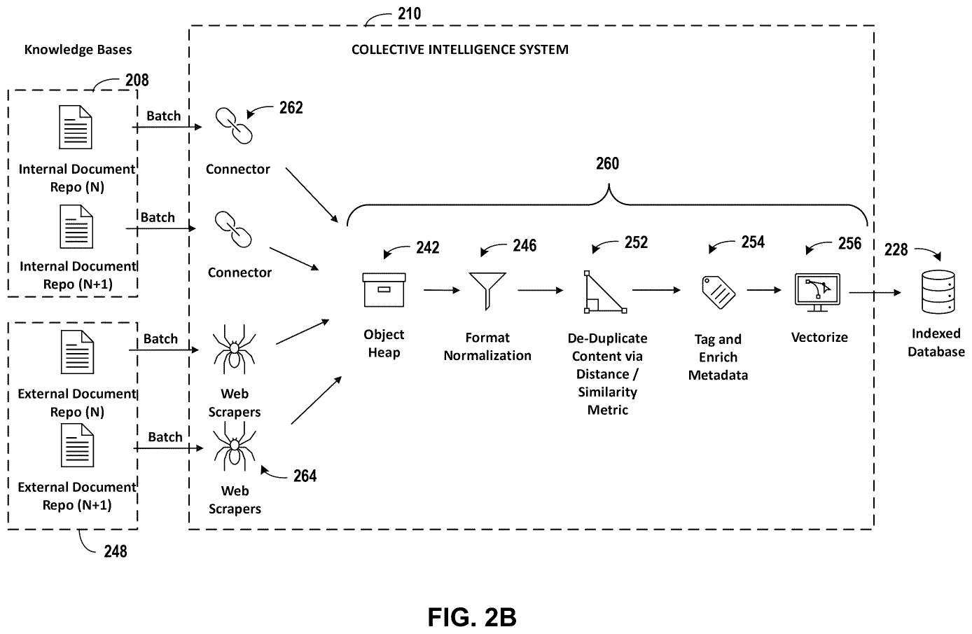

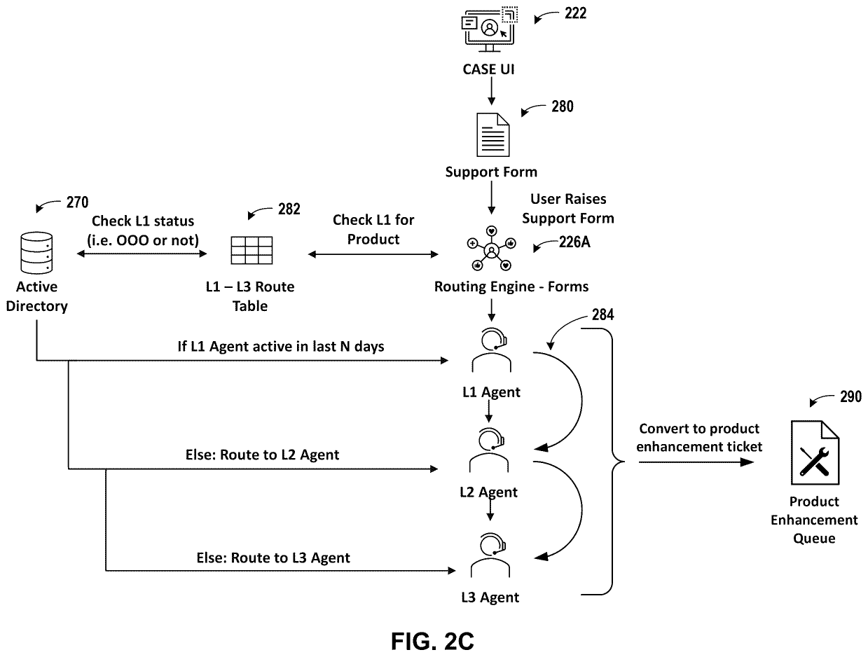

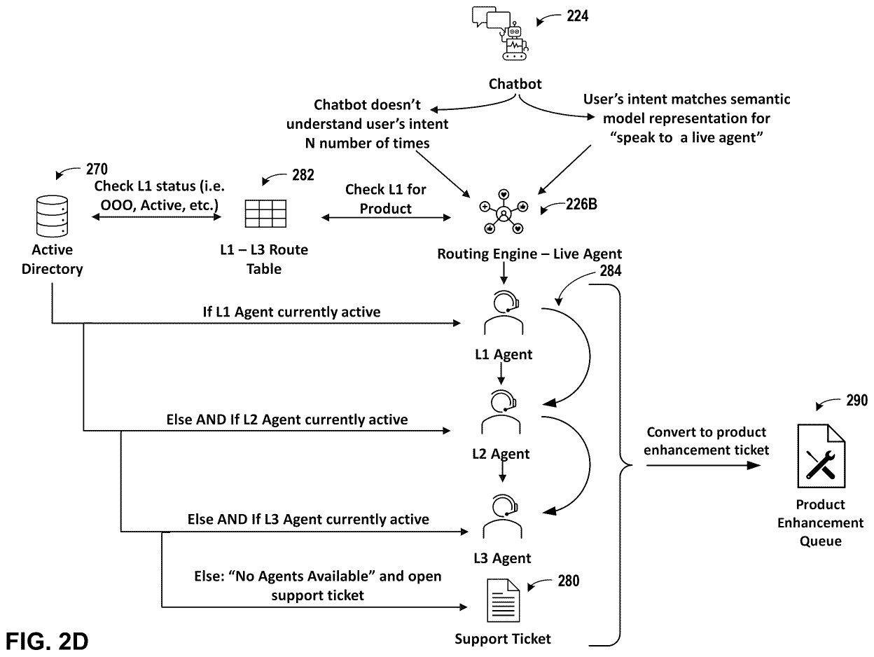

FIG. 2A is a conceptual diagram illustrating example operations of a collective intelligence (CI) system 210 and a CASE system 220, in accordance with one or more aspects of the present disclosure. CI system 210 may operate substantially similar to CI system 110 of FIG. 1 and CASE system 220 may operate substantially similar to CASE system 120 of FIG. 1.

CI system 210 is configured to build a centralized, indexed database 228 from disparate internal data sources 208 and external data sources 248. CI system 210 may be implemented as a microservice that can be deployed across various environments and exposed using APIs. Internal data sources 208 may include data and document repositories associated with one or more enterprise services or data products accessible within a business enterprise network, e.g., private network 102 from FIG. 1. External data sources 248 may comprise data and document repositories associated with one or more cloud services or websites accessible via the Internet, e.g., public network 140 from FIG. 1.

In the illustrated example, CI system 210 includes connectors 262, which may comprise service-specific APIs, configured to periodically batch load documentation from internal data sources 208. CI system 210 also includes web scrapers 264, which may include web crawling and data extraction tools, configured to periodically batch load documentation from external data sources 248. At operation sequence 1, CI system 210 performs data processing operations 260 to batch process content of the documentation, including format normalization, de-duplication, and aggregation of the content. At operation sequence 2, CI system 210 performs further data processing operations 260 to vectorize and index the processed content for search and retrieval in indexed database 228. In some examples, indexed database 228 may comprise a graph database that stores the processed content as a network of entities and relationships using nodes, edges, and properties to represent data. In some scenarios, the processed content may be stored in indexed database 228 according to a structure that mimics a storage structure of the original documentation in either internal data sources 208 or external data sources 248. As such, the processed content stored in indexed database 228 retains its relationship to other content and/or data products.

CI system 210 may re-build indexed database 228 according to a periodic interval, e.g., daily, weekly, monthly, quarterly, or the like. In other examples, instead of batch loading all documentation and completely re-building indexed database 228, CI system 210 may only batch load new or updated documentation since a prior batch load and update indexed data 228 to include the newly processed data.

FIG. 2B is a conceptual diagram illustrating example data processing operations 260 performed by CI system 210 of FIG. 2A in greater detail. Data processing operations 260 of FIG. 2B include object heap 242, format normalization 246, de-duplication 252, tag and enrich metadata 254, and vectorize 256. In other examples, data processing operations 260 may include different or fewer operations than what is illustrated in FIG. 2B.

In the illustrated example, data processing operations 260 include initial storage of all documentation batch loaded from internal data sources 208 and external data sources 248 in an object heap 242. Data processing operations 260 may further include format normalization 246 that normalizes the disparate formats of the documentation in object heap 242 into a single format. For example, format normalization 246 may normalize a knowledge article of one data product or data source that has a page format and another knowledge article of another data product or data source that is formatted as a row in a database table or a list. As one example, format normalization 246 may normalize the format of all documentation into a list format. In other examples, data processing operations 260 may not include a distinct format normalization step and instead connectors 262 and/or web scrapers 264 may be configured to convert the format of the original documentation to a normalized format during the batch load process into object heap 242.

Data processing operations 260 include a de-duplication step 252 that identifies different documents or knowledge articles that describe the same process or tool but are written by different authors, have different time stamps, and/or include different content. De-duplication step 252 may include an automated approach that uses a distance and/or similarity metric to identify two or more documents that are substantially similar and applies a stochastic-or rules-based approach to select one of the two or more documents for inclusion in indexed database 228. In some examples, de-duplication step 252 may also include a manual or human-based approach that sends notifications to each of the authors of the two or more documents to request feedback on the identified similar articles and/or to request permission to archive or update the relative article. De-duplication step 252 may use responses from the authors to assist in the selection of the one of the two or more documents for inclusion in indexed database 228. In some scenarios, de-duplication step 252 may operate as a microservice distinct from CI system 210.

Data processing operations 260 further includes a step to tag and enrich metadata 254. At step 254, CI system 210 may add tags and/or metadata to the processed content to include descriptive, administrative, and structural information (if not already present). Step 254 may include indexing of the processed content based on the tags and/or metadata to make retrieval operations more efficient. For example, CI system 210 may categorize or organize the processed content in accordance with the corresponding tags and/or metadata of the processed content. Data processing operations 260 finally include a vectorizing step 256 to convert the processed content and corresponding tags and/or metadata into a numerical representation for storage in indexed database 228. Vectorization of the processed content enables the content to be used by machine learning and artificial intelligence algorithms. In particular, vectorization of the processed content enables the content within indexed database 228 to be available for semantic search by a search function 222 and/or a chatbot 224 of CASE system 220.

Returning to FIG. 2A, at operation sequence 3, CASE system 220 includes chatbot 224 configured to receive a user query via a user interface, e.g., a chat or conversation window, from requestor 204, determine an intent of the user query, and perform retrieval-augmented generation (RAG) of an answer in response to the user query based on indexed database 228. Based on the intent of the user query being a search request, chatbot 224 may perform RAG of the answer by first performing a search of indexed database 228 via a runtime API call based on the intent of the user query. For example, chatbot 224 may use artificial intelligence to perform a semantic search of indexed database 228 based on the user query. Chatbot 224 then inputs one or more results from the search of indexed database 228 to a large language model (LLM) or other natural language processor (NLP) to generate a natural language answer to the search request. Chatbot 224 may then return the answer for display via the user interface. In some examples, chatbot 224 is configured with multi-turn generative conversations such that answers generated by chatbot 224 may use multiple exchanges between requester 204 and chatbot 224 to refine or improve understanding of the intent of requester 204 and/or quality of the returned answers.

Chatbot 224 of CASE system 220 may be implemented as a microservice that can be deployed across various environments and exposed using APIs. At operation sequence 4, chatbot 224 is published to numerous websites 240 and to an application of CASE system 220, for presentation (along with search function 222) via a front-end user interface of the application. For example, with respect to the application of CASE system 220, chatbot 224 may be embedded onto an application layer of CASE system 220. As an API microservice, chatbot 224 may have plug-and-play capabilities that allows chatbot 224 to be available to users of a wide range of data products and applications.

At operation sequence 5, requester 204 interacts with the front-end user interface of the application of CASE system 220. The front-end user interface of the application includes at least search function 222. As described with respect to operation sequence 4, in some examples, the front-end user interface of the application may also include chatbot 224. Search function 222 receives a user query via the user interface, e.g., a search bar, from requester 204. At operation sequence 6, search function 222 performs a search of indexed database 228 via a runtime API call based on a vectorized version of the user query and, based on identifying at least one result from the search of the indexed database, returns the at least one result for display via the user interface. In some examples, search function 222 may only identifies and return results of sufficient quality in response to the user query. Search function 222 may determine confidence scores associated with one or more potential results from the search of indexed database 228, where each confidence score indicates a likelihood of the associated potential result being accurate for the user query. Based on a confidence score associated with a potential result failing to satisfy a threshold, search function 222 may not identify the potential result as a response to the user query and/or may not return the potential result for display via the user interface.

Based on an inability of either search function 222 and/or chatbot 224 to return an answer or result in response to a user query from requester 204, routing engines 226A, 226B route the user query to an agent 206 selected from a plurality of agents for one of asynchronous or synchronous support for the user query. In one example, search function 222 may be unable to return a result in response to the user query based on confidence scores associated with one or more potential results from the search of indexed database 228 failing to satisfy a threshold. In another example, chatbot 224 may be unable to return an answer in response to the user query based on one of an inability to understand the intent of the user query, confidence scores associated with the one or more results from the search of the indexed database failing to satisfy a threshold, or a determination of the intent to be a request for an agent. In some scenarios, based on an inability of chatbot 224 to return the answer in response to the user query, CASE system 220 may first attempt to use search function 222 to perform a search of indexed database 228 based on the user query before routing the user query to agent 206.

At operation sequence 7, based on a determination that live agent assistance is needed, chatbot 224 (or in some cases search function 222) sends control signals to a live agent routing engine 226B instructing routing engine 226B to route the user query to a live agent 206 for a synchronous live agent session in a chat portal of a chat application 234 between live agent 206 and requester 204. Chatbot 224 may pass a transcript of the chat conversation between requester 204 and chatbot 224 to logs database 230 via an API. Chat application 234 may retrieve the transcript from logs database 230 upon establishment of the synchronous live agent session for use by live agent 206 to understand the user query.

FIG. 2D is a conceptual diagram illustrating an example routing flow for live agent support by CASE system 220 of FIG. 2A. To route the user query to an appropriate live agent, live agent routing engine 226B may determine a data product identified in the user query or otherwise associated with the user query. Routing engine 226B may then determine a set of candidate agents associated with the data product based on a route table 282. In the illustrated example, route table 282 is an L1-L3 route table that includes agents of different knowledge and/or experience levels. For example, a Level 1 (L1) agent may be the least experienced or least knowledgeable agents on a data product, e.g., an associate or senior product owner, which may triage the user queries and escalate those queries that require a higher level of knowledge and/or experience. A Level 2(L2) agent may have a middle level of experience and/or knowledge on the data product, and a Level 3 (L3) agent may have the highest level of experience and/or knowledge on the data product, e.g., a principal product owner or engineer. The set of candidate agents associated with the data product may include one or more agents at each of L1-L3 for the data product.

Routing engine 226B may also determine an activity status of each agent in the set of candidate agents based on an active directory 270 of the enterprise. In this example, active directory 270 maintains activities statuses of the agents, including whether the agent is currently active on the enterprise network, whether the agent has been active during one or more previous days, whether the agent is currently out-of-office and/or has time-off scheduled for one or more subsequent days. Routing engine 226B selects the live agent from the set of candidate agents for the synchronous live agent session for the user query based on the knowledge level and/or the activity status of the agent. Upon selecting an appropriate live agent, routing engine 226B establishes the synchronous live agent session in the chat portal of chat application 234 between live agent 206 and requester 204.

As illustrated in FIG. 2D, routing engine 226B routes the user query to an L1 agent (i.e., the least knowledgeable and/or experienced agent) for the data product if the L1 agent is currently active. If the L1 agent is not currently active (and thus is not immediately available to conduct the synchronous live agent session), routing engine 226B routes the user query to an L2 agent (i.e., a more knowledgeable and/or experienced agent) for the data product if the L2 agent is currently active. If the L2 agent is not currently active, routing engine 226B routes the user query to an L3 agent (i.e., the most knowledgeable and/or experienced agent) for the data product if the L3 agent is currently active. If the L3 agent is not currently active, chatbot 224 may automatically generate a support ticket 280 for the user query in an asynchronous ticketing system, e.g., ticketing system 136 of FIG. 1. For example, chatbot 224 may convert the user query and any necessary transcripts from the chatbot conversation and/or the live agent conversation to generate support ticket 280.

In some cases, based on an indication from the selected live agent, routing engine 226B may escalate 284 the user query from the selected live agent to a higher knowledge level live agent from the set of candidate agents associated with the data product. For example, the L1 agent may initially be selected to participate in the synchronous live agent session but, based on the transcript retrieved from logs database 230 and/or the live conversation with requestor 204, determine that a higher level of knowledge and/or experience on the data product is required to assist requestor 204. The L1 agent may indicate a need for escalation and routing engine 226B may, in turn, escalate 284 the user query (and the associated synchronous live agent session) to a currently active L2 agent of the set of candidate agents. The L2 agent may initiate a similar escalation process, if necessary, to escalate the user query (and the associated synchronous live agent session) to a currently active L3 agent of the set of candidate agents.

In some scenarios, based on an indication from the selected live agent, CASE system 220 may generate a product enhancement ticket for inclusion in a product enhancement queue 290 to modify at least a portion of the data product based on the user query. The selected live agent may manually generate the product enhancement ticket or CASE system 220, e.g., using chatbot 224, may automatically generate at least a portion of the product enhancement ticket based on the user query and any necessary transcripts from the chatbot conversation and/or the live agent conversation. CASE system 220 may then send control signals to one or more computing devices, e.g., product management systems 190 from FIG. 1, instructing the one or more computing devices to include the product enhancement ticket in a queue of issues feature enhancements for the data product. In some cases, an L3 agent on the data product (e.g., a product owner or engineer) or an automated process may triage product enhancement tickets received at the relative product management system and determine whether to accept a product enhancement ticket into the queue or close the ticket.

Returning to FIG. 2A, at operation sequence 8, based on an indication from requester 204 in the user interface of the application of CASE system 220, search function 222 or chatbot 224 sends control signals to a forms routing engine 226A instructing routing engine 226A to route the user query to an agent 206 for asynchronous support via an asynchronous ticketing system, e.g., ticketing system 136 from FIG. 1. In one example, search function 222 or chatbot 224 sends control signals to forms routing engine 226A instructing routing engine 226A to route requester 204 to the asynchronous ticketing system for requester 204 to generate a support ticket 280 for the user query. In another example, CASE system 220, e.g., using chatbot 224, may automatically generate support ticket 280 for the user query in the asynchronous ticketing system. In some examples, support ticket 280 may include a transcript of a chat conversation between requester 204 and chatbot 224 and/or search results from search function 222 associated with the user query.

FIG. 2C is a conceptual diagram illustrating an example routing flow for support forms by CASE system 220 of FIG. 2A. To route support form 280 of a user query to an appropriate agent, form routing engine 226A may determine a data product identified in the support form and/or user query or otherwise associated with the support form and/or user query. Routing engine 226A may then determine a set of candidate agents associated with the data product based on route table 282. In the illustrated example, route table 282 is an L1-L3 route table that includes agents of different knowledge and/or experience levels, such as L1 agents having the least experience or least knowledge on a data product, L2 agents having a middle level of experience and/or knowledge on the data product, and L3 agents having the highest level of experience and/or knowledge on the data product. The set of candidate agents associated with the data product may include one or more agents at each of L1-L3 for the data product.

Routing engine 226A may also determine an activity status of each agent in the set of candidate agents based on an active directory 270 of the enterprise. Routing engine 226A selects the agent from the set of candidate agents for support ticket 280 based on the knowledge level and/or the activity status of the agent. For example, routing engine 226A may select the agent based on the activity status indicating that the agent was active during one or more previous days, e.g., the last N days, where N may be 1-3 days. In some examples, routing engine 226A may also select the agent based on the activity status indicating that the agent does not have time-off scheduled for one or more subsequent days. Although the ticketing system is asynchronous, routing engine 226A attempts to select an agent for support ticket 280 that is expected to be available to handle support ticket 280 within a reasonable amount of time, e.g., within a service level agreement (SLA) time period of 1-3 days. Upon selecting an appropriate agent, routing engine 226A routes support ticket 280 for the user query to the selected agent via the asynchronous ticketing system.

As illustrated in FIG. 2C, routing engine 226A routes support ticket 280 to an L1 agent (i.e., the least knowledgeable and/or experienced agent) for the data product if the L1 agent was active in the last N days. If the L1 agent was not active in the last N days (and thus may not be available to handle support ticket 280 within the SLA time period), routing engine 226A routes support ticket 280 to an L2 agent (i.e., a more knowledgeable and/or experienced agent) for the data product if the L2 agent was active in the last N days. If the L2 agent was not active in the last N days, routing engine 226A routes support ticket 280 to an L3 agent (i.e., the most knowledgeable and/or experienced agent) for the data product.

In some cases, based on an indication from the selected agent, routing engine 226A may escalate 284 support ticket 280 from the selected agent to a higher knowledge level agent from the set of candidate agents associated with the data product. For example, the L1 agent may initially be selected to handle support ticket 280 but, based on the user query and associated information included in the ticket, determine that a higher level of knowledge and/or experience on the data product is required to handle support ticket 280. The L1 agent may indicate a need for escalation and routing engine 226A may, in turn, escalate 284 support ticket 280 to an L2 agent of the set of candidate agents. The L2 agent may initiate a similar escalation process, if necessary, to escalate support ticket 280 to an L3 agent of the set of candidate agents.

In some scenarios, based on an indication from the selected agent, CASE system 220 may generate a product enhancement ticket for inclusion in a product enhancement queue 290 to modify at least a portion of the data product based on the user query. The selected agent may manually generate the product enhancement ticket or CASE system 220, e.g., using chatbot 224, may automatically generate at least a portion of the product enhancement ticket based on the user query and any associated information. CASE system 220 may then send control signals to one or more computing devices, e.g., product management systems 190 from FIG. 1, instructing the one or more computing devices to include the product enhancement ticket in a queue of issues feature enhancements for the data product. In some cases, an L3 agent on the data product (e.g., a product owner or engineer) or an automated process may triage product enhancement tickets received at the relative product management system and determine whether to accept a product enhancement ticket into the queue or close the ticket.

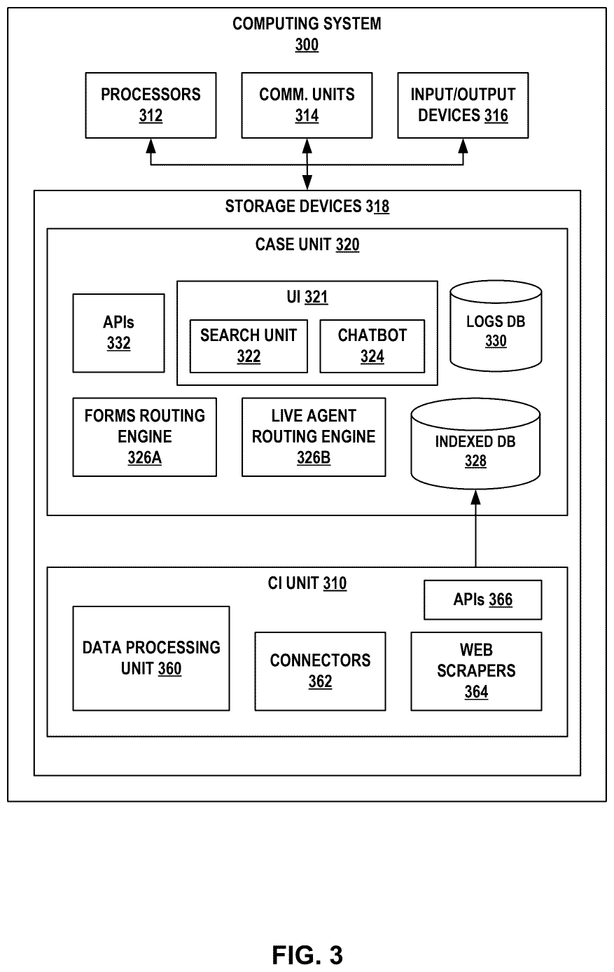

FIG. 3 is a block diagram illustrating an example computing system 300 including a CASE unit 320 and a collective intelligence (CI) unit 310, in accordance with one or more aspects of the present disclosure. Computing system 300 may generally correspond to a group of computing devices that includes and/or implements aspects of the functionality of CASE system 120 of FIG. 1 and/or CASE system 220 of FIG. 2A and CI system 110 of FIG. 1 and/or CI system 210 of FIGS. 2A, 2B.

Computing system 300 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, Computing system 300 represents a cloud computing system, server farm, and/or server cluster (or portion thereof) that provides services to client devices and other devices or systems.

Although computing system 300 of FIG. 3 is illustrated as a stand-alone device, in other examples computing system 300 may be implemented in any of a wide variety of ways, and may be implemented using multiple devices and/or systems. In some examples, computing system 300 may be, or may be part of, any component, device, or system that includes a processor or other suitable computing environment for processing information or executing software instructions and that operates in accordance with one or more aspects of the present disclosure. In some examples, computing system 300 may be fully implemented as hardware in one or more devices or logic elements.

In the example of FIG. 3, computing system 300 includes one or more processors 312, one or more communication units 314, one or more input/output devices 316, and one or more storage devices 318. In the illustrated example, storage devices 318 include CASE unit 320 and CI unit 310. CASE unit 320 includes a user interface (UI) module 321 including a search function 322 and a chatbot 324, a forms routing engine 326A, a live agent routing engine 326B, an indexed database 328, a logs database 330, and one or more APIs 332. CI unit 310 includes a data processing unit 360, connectors 362, web scrapers 364, and one or more APIs 366. One or more of the devices, modules, storage areas, or other components of computing system 300 may be interconnected to enable inter-component communications (physically, communicatively, and/or operatively). In some examples, such connectivity may be provided by through communication channels, a system bus, a network connection, an inter-process communication data structure, or any other method for communicating data. A power source (not shown) is provide power to one or more components of computing system 300. In some examples, the power source may receive power from the primary alternative current (AC) power supply in a commercial building or data center, where some or all of an enterprise network may reside. In other examples, the power source may be or may include a battery.

One or more processors 312 of computing system 300 may implement functionality and/or execute instructions associated with computing system 300 associated with one or more modules illustrated herein and/or described below. One or more processors 312 may be, may be part of, and/or may include processing circuitry that performs operations in accordance with one or more aspects of the present disclosure. Examples of processors 312 include microprocessors, application processors, display controllers, auxiliary processors, one or more sensor hubs, and any other hardware configured to function as a processor, a processing unit, or a processing device. Computing system 300 may use one or more processors 312 to perform operations in accordance with one or more aspects of the present disclosure using software, hardware, firmware, or a mixture of hardware, software, and firmware residing in and/or executing at computing system 300.

One or more communication units 314 of computing system 300 may communicate with devices external to computing system 300 by transmitting and/or receiving data, and may operate, in some respects, as both an input device and an output device. In some examples, communication units 314 may communicate with other devices over a network. In other examples, communication units 314 may send and/or receive radio signals on a radio network such as a cellular radio network. In other examples, communication units 314 of computing system 300 may transmit and/or receive satellite signals on a satellite network such as a Global Positioning System (GPS) network. Examples of communication units 314 include a network interface card (e.g., such as an Ethernet card), an optical transceiver, a radio frequency transceiver, a GPS receiver, or any other type of device that can send and/or receive information. Other examples of communication units 314 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input/output devices 316 may represent any input or output devices of computing system 300 not otherwise separately described herein. One or more input/output devices 316 may generate, receive, and/or process input from any type of device capable of detecting input from a human or machine. One or more input/output devices 316 may generate, present, and/or process output through any type of device capable of producing output.

One or more storage devices 318 within computing system 300 may store information for processing during operation of computing system 300. Storage devices 318 may store program instructions and/or data associated with one or more of the modules described in accordance with one or more aspects of this disclosure. One or more processors 312 and one or more storage devices 318 may provide an operating environment or platform for such modules, which may be implemented as software, but may in some examples include any combination of hardware, firmware, and software. One or more processors 312 may execute instructions and one or more storage devices 318 may store instructions and/or data of one or more modules. The combination of processors 312 and storage devices 318 may retrieve, store, and/or execute the instructions and/or data of one or more applications, modules, or software. Processors 312 and/or storage devices 318 may also be operably coupled to one or more other software and/or hardware components, including, but not limited to, one or more of the components of computing system 300 and/or one or more devices or systems illustrated as being connected to computing system 300.

In some examples, one or more storage devices 318 are temporary memories, meaning that a primary purpose of the one or more storage devices is not long-term storage. Storage devices 318 of computing system 300 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 318, in some examples, also include one or more computer-readable storage media. Storage devices 318 may be configured to store larger amounts of information than volatile memory. Storage devices 318 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

According to the disclosed techniques, computing system 300 provides self-service functionality for data analytics with built-in support guidance. CI unit 310 comprises instructions that, when executed, cause processors 312 to build indexed database 328 from disparate internal and external data sources. Connectors 262, which may comprise service-specific APIs, and web scrapers 264, which may include web crawling and data extraction tools, periodically batch load documentation from the disparate internal and external data sources. Data processing unit 360 then batch processes content of the documentation, including format normalization, de-duplication, indexing, and vectorizing the processed content for search and retrieval in indexed database 328. In some examples, CI unit 310 may batch load and process the documentation once per day, oncer per week, once per month, or the like. CI unit 310 may be implemented as a microservice that can be deployed across various environments and exposed using APIs 366.

CASE unit 320 provides an end-to-end workflow that seamlessly interconnects a front-end UI 321 for self-service data and/or analytics access with synchronous and asynchronous human agent support systems via routing engines 326A, 326B. CASE unit 320 comprises instructions that, when executed, cause processors 312 to provide a front-end UI 321 as both search function 322 and chatbot 324. Each of search function 322 and chatbot 324 receive user queries regarding data and/or data analytics via UI 321 and return answers or results in response to the user queries based on indexed database 328. Search function 322 may perform a search of indexed database 328 via a runtime API call using APIs 332 based on a vectorized version of the user query and return at least one result for display via UI 321. Chatbot 324 may determine an intent of the user query and perform RAG of an answer to the user query, where the RAG includes performing a search of indexed database 328 via a runtime API call using APIs 332 based on the intent of the user query and generating a natural language answer to the search request based on one or more results from the search of the indexed database input to an LLM. Chatbot 324 then returns the answer for display via UI 321.

In situations where chatbot 324 and/or search function 322 are unable to return an answer or result of sufficient quality in response to a user query, CASE unit 320 facilitates either asynchronous or synchronous support for the user query. As one example, CASE unit 320 includes forms routing engine 326A to redirect the user query to an appropriate agent via an asynchronous ticketing system, e.g., ticketing system 136 from FIG. 1. In this example, CASE unit 320, e.g., using chatbot 324, may automatically generate and submit a support ticket for the user query to ticketing system 136 or may route a user or requester that submitted the user query to ticketing system 136 to manually generate and submit the support ticket for the user query. Routing engine 326A may select the appropriate agent to handle the support ticket based on a data product or other context identified in the user query, expertise or knowledge level of the agents associated with the identified data product or other context, and/or availability of the agents based on data retrieved from an active directory via APIs 332. For example, routing engine 326A may initially select an agent that was active on the enterprise network during one or more previous days.

As another example, CASE unit 320 includes live agent routing engine 326B to redirect the user query to an appropriate agent via a synchronous live agent session, e.g., in a chat portal of chat application 134 from FIG. 1. Chatbot 324 may log transcripts of multi-turn chat conversations with requesters in response to initial user queries in logs database 330 using APIs 332. Upon initiating the synchronous live agent session for the user query, the chat portal of chat application 134 may retrieve the corresponding transcript associated with the user query from logs database 330 using APIs 332. In some examples, ticketing system 136 may also retrieve any corresponding transcript associated with the user query from logs database 330 using APIs 332 and include the corresponding transcript in the support ticket. Routing engine 326B may select the appropriate agent to participate in the live agent session with the user or requester based on a data product or other context identified in the user query, expertise or knowledge level of the agents associated with the identified data product or other context, and/or availability of the agents based on data retrieved from an active directory via APIs 332. For example, routing engine 326B may initially select an agent that is currently active on the enterprise network.

In some scenarios, as part of the asynchronous or synchronous support for the user query, the selected agent may identify a feature enhancement for the data product identified in the user query. Based on an indication from the selected agent, CASE unit 320, e.g., using chatbot 324, may generate a product enhancement ticket to modify at least a portion of the data product based on the user query, and send control signals to one or more computing devices, e.g., product management systems 190 of FIG. 1, via communication unit 314 of computing system 300. The control signals may instruct the one of product management system 190 associated with the data product to include the product enhancement ticket in a queue of issues and feature enhancements for the data product.

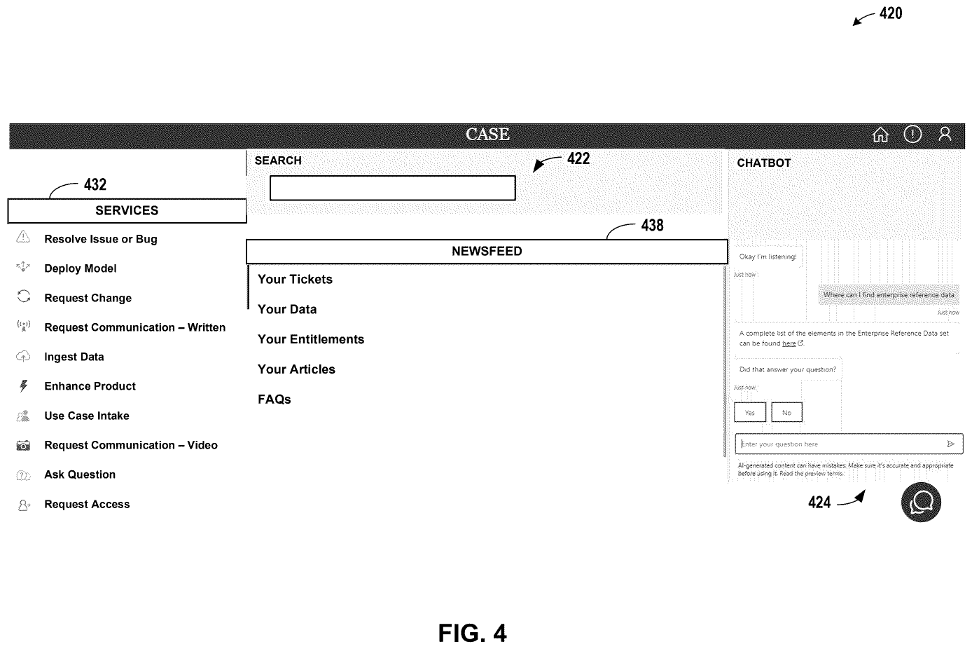

FIG. 4 illustrates an example user interface 420 of a CASE system, in accordance with one or more aspects of the present disclosure. User interface 420 may be included as a front-end of an application, e.g., of CASE system 120 of FIG. 1, CASE system 220 of FIG. 2A, or CASE unit 320 of computing system 300 of FIG. 3. In some examples, user interface 420 may operate substantially similar to UI 321 of CASE unit 320 from FIG. 3.

As illustrated in FIG. 4, user interface 420 includes both a search bar 422 of a search function 422 and a conversation window 424 of a chatbot. For example, search bar 422 of the search function provides a text field into which a user or requester can type or otherwise input a query, e.g., search terms, using an input device of a computing device, e.g., one of requestor devices 104 from FIG. 1. Based on identifying at least one search result with an adequate confidence score, the search function returns the at least one result for display via user interface 420. As another example, conversation window 424 of the chatbot provides a text field into which a user or requester can type or otherwise input a query, e.g., a natural language question or request, using an input device of a computing device, e.g., one of requestor devices 104 from FIG. 1. Based on determining an intent of the query and identifying one or more search results with adequate confidence scores, the chatbot inputs the one or more search results to an LLM to generate natural language answer and returns the answer for display in conversation window 424 of user interface 420.

In the illustrated example of FIG. 4, user interface 420 also includes services 432, which include a menu or list of linked services for selection by a user or requester. For example, services 432 include “resolve issue or bug,” “deploy model,” “request change,” “request communication—written,” “ingest data,” “enhance product,” “use case intake,” “request communication—video,” “ask question,” and “request access.” In some example, the user or requester may click or otherwise select one of services 432 using an input device of a computing device, e.g., one of requestor devices 104 from FIG. 1, and be directed or routed to a portion of user interface 420 or to another application, system, or computing device for performance of the selected service.

In addition, user interface 420 includes a newsfeed 438 that may be constructed based on an algorithm customized to a current user or requester. As illustrated, newsfeed 438 includes “your tickets,” which may display a customized history of support requests from the user and/or permit the user to manually submit a support ticket and track ticket progress, “your data,” which may display or link to recent data and/or data analytics requested by the user, “your entitlements,” which may display or link to products, systems, or data to which the user has access, “your articles,” which may display or link to customized articles, “FAQs,” which may display customized frequently asked questions based on the user's history and associated products and data.

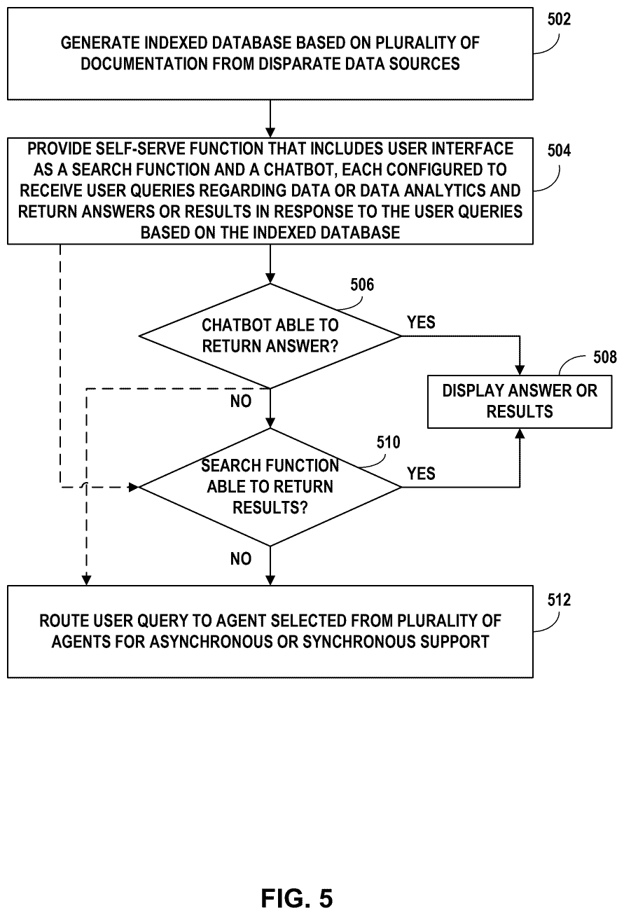

FIG. 5 is a flowchart illustrating example operations to provide self-service functionality for data analytics with built-in support guidance, in accordance with one or more aspects of the present disclosure. The operations of FIG. 5 are described with respect to CI system 110 and CASE system 120 of FIG. 1. In other examples, operations described in FIG. 5 may be performed by CI system 210 and/or CASE system 220 of FIGS. 2A-2D or CI unit 310 and/or CASE unit 320 of computing system 300 from FIG. 3. In some examples, operations described in connection with FIG. 5 may be merged, performed in a difference sequence, or omitted.

CI system 110 generates an indexed database 128 based on a plurality of documentation from disparate data sources, e.g., internal data sources 108 and external data sources 148 (502). For example, CI system 110 may periodically batch load the plurality of documentation from disparate data sources 108, 148, process content of the plurality of documentation, including format normalization, de-duplication, vectorization, and indexing of the content, and store the processed content in indexed database 128 for search and retrieval.

CASE system 120 provides a self-service function that includes a user interface as a search function 122 and a chatbot 124, each configured to receive user queries regarding at least one of data or data analytics and return answers or results in response to the user queries based on indexed database 128 (504). CASE system 120 may provide at least search function 122, and in some examples chatbot 124, in an application of CASE system 120. In other examples, CASE system 120 may provide chatbot 124 as an API microservice in one or more of websites hosted by web servers 150.

In one example, chatbot 124 may receive a user query via the user interface, determine an intent of the user query, based on determining the intent to be a search request, and perform RAG that includes a search of indexed database 128 based on the intent of the user query and generation of a natural language answer to the search request based on one or more results from the search of indexed database 128 (506). If chatbot 124 is able to return an answer in response to the user query (YES branch of 506), chatbot 124 displays the answer via the user interface (508).

In another example, search function 122 may receive a user query from a user or requester using one of requester devices 104 via the user interface and perform a search of indexed database 128 based on a vectorized version of the user query (510). If search function 122 is able to return at least one result in response to the user query (YES branch of 510), search function 122 displays the result via the user interface (508). In some examples, if chatbot 124 is unable to return an answer in response to the user query (NO branch of 506), CASE system 220 may then use search function 122 to perform a search of indexed database 128 based on the user query (510).

If chatbot 124 is unable to return an answer in response to the user query (NO branch of 506) and/or if search function 122 is unable to return the result in response to the user query (NO branch of 510), routing engines 126 of CASE system 120 route the user query to an agent selected from a plurality of agents using agent devices 106 for one of asynchronous or synchronous support for the user query (506). For example, routing engines 126 may determine a data product identified in the user query, determine a set of candidate agents associated with the data product, determine an activity status of each agent in the set of candidate agents based on active directory 170, and select the agent from the set of candidate agents for the one of asynchronous or synchronous support for the user query based on the activity status of the agent.

In the case of synchronous support, one of routing engines 126 selects the agent from the set of candidate agents based on the activity status of the agent indicating that the agent is currently available, and establishes a synchronous live agent session in a chat portal of chat application 134 between the agent using one of agent devices 106 and the user or requester using one of requester devices 104. In the case of asynchronous support, one of routing engines 126 routes the user or requester from which the user query was received to an asynchronous ticketing system 136 for the user or requester to generate a support ticket for the user query using one of requester devices 104. In some scenarios, instead of the user or requester manually generating the support ticket, chatbot 124 may automatically generate the support ticket for the user query in asynchronous ticketing system 136. In either scenario, the one of routing engines 126 selects the agent from the set of candidate agents based on the activity status of the agent indicating that the agent was active during one or more previous days, and routes the support ticket for the user query to the selected agent via asynchronous ticketing system 136.

In some examples, the user query may identify a data product associated with the at least one of data or data analytics, which may be used as context to improve the search of indexed database 128 by either search function 122 or chatbot 124. CASE system 120 may be configured to, based on an indication from the selected agent via either the chat application 134 or the asynchronous ticketing system 136, generate a product enhancement ticket to modify at least a portion of the data product based on the user query and send control signals to product management systems 190 instructing the corresponding one of product management systems 190 to include the product enhancement ticket in a queue.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of computer program from one place to another, e.g., according to a communication protocol. In this manner, computer-readable storage media generally may correspond to (1) tangible computer-readable storage media which is non-transitory or (2) a communication media such as signal or carrier wave. Data storage media may be any available media that can be accessed by one or more computers or one or more processing circuits to receive instructs, code and/or data structures for implementation of the techniques described in this disclosure. A computer program product may include a computer-readable medium.

By way of example and not limitation, such computer-readable storage media may include RAM, ROM, EEPROM, CD-ROM, or other optical disk storage, magnetic disk storage, or other magnetic storage devices, flash memory, cache memory, or any other medium that can be used to store desired program code in the form of instructions or store data structures and that can be access by a computer. Also, any connection is a properly termed a computer-readable medium. For example, if instructions are transmitted from a website, server, or other remote source using a coaxial cable, fiber optic cable, twisted pair, digital subscriber line (DSL), or other wireless technologies such as infrared, radio, and microwave, then the coaxial cable, fiber optic cable, twisted pair, DSL, or other wireless technologies such as infrared, radio, and microwave are included in the definition of medium. It should be understood, however, that computer-readable storage media and data storage media do not include connections, carrier waves, signals, or other transient media, but are directed to non-transient, tangible storage media. Disk and disc, as used herein, includes compact disk (CD), laser disc, optical disc, digital versatile disc (DVD), and Blu-ray disc, where disks usually reproduce data magnetically, while discs reproduce data optically with lasers. Combinations of the above should be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure of any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chip set). Various components, modules, software systems, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A computing system comprising:
memory; and
processing circuitry in communication with the memory and configured to:
generate an indexed database based on a plurality of documentation from disparate data sources;
provide a self-service function that includes a user interface as a search function and a chatbot, each configured to receive user queries regarding at least one of data or data analytics and return answers or results in response to the user queries based on the indexed database; and
based on an inability to return an answer or result in response to a user query, route the user query to an agent selected from a plurality of agents for one of asynchronous or synchronous support for the user query.

2. The computing system of claim 1, wherein the user query identifies a data product associated with the at least one of data or data analytics, and wherein the processing circuitry is configured to:
based on an indication from the selected agent, generate a product enhancement ticket to modify at least a portion of the data product based on the user query; and
send control signals to one or more computing devices instructing the one or more computing devices to include the product enhancement ticket in a queue.

3. The computing system of claim 1, wherein to generate the indexed database, the processing circuitry is configured to:
periodically batch load the plurality of documentation from the disparate data sources;
process content of the plurality of documentation, including format normalization, de-duplication, vectorization, and indexing of the content; and
store the processed content in the indexed database for search and retrieval.

4. The computing system of claim 3, wherein to periodically batch load the plurality of documentation, the processing circuitry is configured to:
periodically batch load documentation from one or more internal document repositories associated with one or more enterprise services via one or more service-specific connectors or application programming interfaces (APIs); and
periodically batch load documentation form one or more external document repositories associated with one or more websites via one or more web scrapers.

5. The computing system of claim 1, wherein to provide the user interface as the search function, the processing circuitry is configured to provide the search function in an application.

6. The computing system of claim 1, wherein to provide the user interface as the search function, the processing circuitry is configured to:
receive the user query via the user interface;
perform a search of the indexed database via a runtime application programming interface (API) call based on a vectorized version of the user query; and
based on identifying at least one result from the search of the indexed database, return the at least one result for display via the user interface.

7. The computing system of claim 6, wherein the processing circuitry is configured to determine that the search function is unable to return the result in response to the user query based on confidence scores associated with one or more potential results from the search of the indexed database failing to satisfy a threshold.

8. The computing system of claim 1, wherein to provide the user interface as the chatbot, the processing circuitry is configured provide the chatbot as an application programming interface (API) microservice in at least one of an application or a website.

9. The computing system of claim 1, wherein to provide the user interface as the chatbot, the processing circuitry is configured to:
receive the user query via the user interface;
determine an intent of the user query;
based on determining the intent to be a search request, perform retrieval-augmented generation (RAG) that includes a search of the indexed database via a runtime application programming interface (API) call based on the intent of the user query and generation of a natural language answer to the search request based on one or more results from the search of the indexed database input to a large language model (LLM); and
return the answer for display via the user interface.

10. The computing system of claim 9, wherein the processing circuitry is configured to determine that the chatbot is unable to return the answer in response to the user query based on one of:
an inability to understand the intent of the user query;
confidence scores associated with the one or more results from the search of the indexed database failing to satisfy a threshold; or
a determination of the intent to be a request for an agent.

11. The computing system of claim 1, wherein the processing circuitry is configured to, based on an inability of the chatbot to return the answer in response to the user query, use the search function to perform a search of the indexed database based on the user query.

12. The computing system of claim 1, wherein to route the user query to the selected agent, the processing circuity is configured to:
determine a data product identified in the user query;
determine a set of candidate agents associated with the data product;
determine an activity status of each agent in the set of candidate agents based on an active directory; and
select the agent from the set of candidate agents for the one of asynchronous or synchronous support for the user query based on the activity status of the agent.

13. The computing system of claim 12, wherein to route the user query to the selected agent for synchronous support, the processing circuity is configured to:
select the agent from the set of candidate agents based on the activity status of the agent indicating that the agent is currently available; and
establish a synchronous live agent session in a chat portal between the first agent and a user from which the user query was received.

14. The computing system of claim 13, wherein based on no agent of the set of candidate agents being currently available, automatically generate a support ticket for the user query in an asynchronous ticketing system.

15. The computing system of claim 12, wherein to route the user query to the selected agent for asynchronous support, the processing circuity is configured to:
route a user from which the user query was received to an asynchronous ticketing system for the user to generate a support ticket for the user query;
select the agent from the set of candidate agents based on the activity status of the agent indicating that the agent was active during one or more previous days; and
route the support ticket for the user query to the selected agent via the asynchronous ticketing system.

16. The computing system of claim 12, wherein to route the user query to the selected agent for asynchronous support, the processing circuity is configured to:
automatically generate a support ticket for the user query in an asynchronous ticketing system;
select the agent from the set of candidate agents based on the activity status of the agent indicating that the agent was active during one or more previous days; and
route the support ticket for the user query to the selected agent via the asynchronous ticketing system.

17. The computing system of claim 12, wherein the processing circuitry is configured to, based on an indication from the selected agent, escalate the user query from the selected agent to a higher knowledge level agent from the set of candidate agents associated with the data product for the one of asynchronous or synchronous support for the user query.

18. The computing system of claim 12, wherein to select the agent from the set of candidate agents, the processing circuitry is configured to:
identify a first agent from the set of candidate agents based on a first knowledge level of the first agent;
based on the activity status of the first agent indicating that the first agent is not available, selecting a second agent from the set of candidate agents based on a second knowledge level of the second agent and the activity status of the second agent indicating that the second agent is available, wherein the second knowledge level is higher than the first knowledge level.

19. A method comprising:
generating, by a computing system, an indexed database based on a plurality of documentation from disparate data sources;
providing, by the computing system, a self-service function that includes a user interface as a search function and a chatbot, each configured to receive user queries regarding at least one of data or data analytics and return answers or results in response to the user queries based on the indexed database; and
based on an inability to return an answer or result in response to a user query, routing, by the computing system, the user query to an agent selected from a plurality of agents for one of asynchronous or synchronous support for the user query.

20. Non-transitory computer readable media comprising instructions that, when executed, cause one or more programmable processors to:
generate an indexed database based on a plurality of documentation from disparate data sources;
provide a self-service function that includes a user interface as a search function and a chatbot, each configured to receive user queries regarding at least one of data or data analytics and return answers or results in response to the user queries based on the indexed database; and
based on an inability to return an answer or result in response to a user query, route the user query to an agent selected from a plurality of agents for one of asynchronous or synchronous support for the user query.
